(19) United States
(12) Patent Application Publication
(10) Pub. No.: US 2007/0299846 A1
(43) Pub. Date: Dec. 27, 2007

(54) System and method for meta-data driven instrumentation

(75) Inventors: Arieh Markel, Broomfield, CO (US); Brandon Eugene Taylor, Longmont, CO (US); Peter H. Schow, Longmont, CO (US); Alexander G. Vul, Palo Alto, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/472,614

(22) Filed: Jun. 22, 2006

(51) Int. Cl. G06F 17/30

(52) U.S. Cl. 707/10

(57) ABSTRACT

A method for managing an asset includes receiving a management request for the asset from a management application where the management request complies with an information model format, identifying a data acquisition (DAQ) definition for the management request, translating the management request from the information model format to a data acquisition format, where the DAQ definition complies with the data acquisition format, triggering a protocol handler according to the DAQ definition, and managing the asset using the protocol handler.

### CROSS-REFERENCE TO RELATED APPLICATIONS

The present application contains subject matter that may be related to the subject matter in the following U.S. patent applications, which are all assigned to a common assignee: “System and Method for Meta-data Driven Instrumentation” (Attorney Docket No. 03226/811001; SUN060472) filed on Jun. 22, 2006; “Resource Discovery and Enumeration in the Meta-Data Driven Instrumentation” (Attorney Docket No. 03226/812001; SUN060473) filed on Jun. 22, 2006; “System and Method for Object-Oriented Meta-Data Driven instrumentation” (Attorney Docket No. 03226/813001; SUN060474) filed on Jun. 22, 2006; “System and Method for Native-Asset-Interface Libraries for Instrumentation” (Attorney Docket No. 03226/814001; SUN060475) filed on Jun. 22, 2006; “Asynchronous Events in Meta-Data Driven Instrumentation” (Attorney Docket No. 03226/815001; SUN060476) filed on Jun. 22, 2006; “System and Method for Efficient Meta-Data Driven Instrumentation” (Attorney Docket No. 03226/816001; SUN060477) filed on Jun. 22, 2006; and “System and Method for Mapping between Instrumentation and Information Model” (Attorney Docket No. 03226/817001; SUN060478) filed on Jun. 22, 2006.

### BACKGROUND

A network corresponds to an interconnection of more than one computer system. For example, one type of network is a home network. A home network may correspond to two or more personal computers that can exchange data with each other and the Internet. Different types of networks exist throughout society. For example, large organizations often have data centers, servers, and various personal computer systems to exchange information between users, and to provide processing power to a single user.

In order to provide such functionality, a network includes various types of hardware and software. For example, the hardware includes the computer systems (personal computers, servers, and other such computing devices), network interface hardware, interconnection mediums (e.g., cables, wireless signals, etc.) routers, switches, hubs, and other such hardware. The software is instructions for providing the functionality of the network. For example, the software may include operating systems, network specific applications, user applications, server applications, etc.

In order to keep a network operating properly, the network must be managed. Managing a network involves managing the different resources (i.e., hardware and software) of the network. Typically, a resource can be managed through an application programming interface (API) of the resource. An application programming interface is the interface that a resource provides in order to allow management requests for service and management data to be made of the resource by management applications. Specifically, a management application that has knowledge of the application programming interface of the resource can manage the resource by accessing the different functions and data available through the application programming interface of the resource.

### SUMMARY

In general, in one aspect, the invention relates to a method for managing an asset. The method includes receiving a management request for the asset from a management application, wherein the management request complies with an information model format, identifying a data acquisition (DAQ) definition for the management request, translating the management request from the information model format to a data acquisition format, wherein the DAQ definition complies with the data acquisition format, triggering a protocol handler according to the DAQ definition, and managing the asset using the protocol handler.

In general, in one aspect, the invention relates to a system for managing an asset. The system includes a data acquisition (DAQ) definition, and a DAQ manager configured to receive a management request for the asset, identify the DAQ definition for the management request, and trigger a protocol handler according to the DAQ definition, wherein the asset is managed using the protocol handler, wherein the management request complies with an information model format, and wherein the management request is translated from the information model format to a data acquisition format, wherein the DAQ definition complies with the data acquisition format.

In general, in one aspect, the invention relates to a distributed computer system. The distributed computer system includes a plurality of nodes for performing a method that includes receiving a management request for an asset from a management application, wherein the management request complies with an information model format, identifying a DAQ definition for the management request, translating the management request from the information model format to a data acquisition format, wherein the DAQ definition complies with the data acquisition format, triggering a protocol handler according to the DAQ definition, and managing the asset using the protocol handler, wherein the management application and the protocol handler are executing on one or more of the plurality of nodes.

Other aspects of the invention will be apparent from the following description and the appended claims.

### BRIEF DESCRIPTION OF DRAWINGS

FIG. 1 shows a schematic diagram of a system for managing assets in accordance with one or more embodiments of the invention.

FIG. 2 shows a schematic diagram of information model instances for an asset type in accordance with one or more embodiments of the invention.

FIG. 3 shows a schematic diagram of a data acquisition runtime used for managing assets in accordance with one or more embodiments of the invention.

FIG. 4 shows a flowchart of a method for adding a new asset type to the system in accordance with one or more embodiments of the invention.

FIG. 5 shows a flowchart of a method for processing a management request in accordance with one or more embodiments of the invention.

FIG. 6 shows a flowchart of a method for managing an asset at the data acquisition runtime in accordance with one or more embodiments of the invention.

FIG. 7 shows a flowchart of an example of providing asset management information in accordance with one or more embodiments of the invention.

FIG. 8 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and apparatus for managing assets. Specifically, embodiments of the invention provide a mechanism for managing assets of different asset types through a common interface. Managing an asset includes monitoring the asset, actively managing the asset, registering the asset, or performing any other function on the asset. More specifically, embodiments of the invention abstract the application programming interface from the management data and functionality associated with a single asset. Using the abstraction, a management application and information model can manage an asset without knowing the application programming interface of the asset.

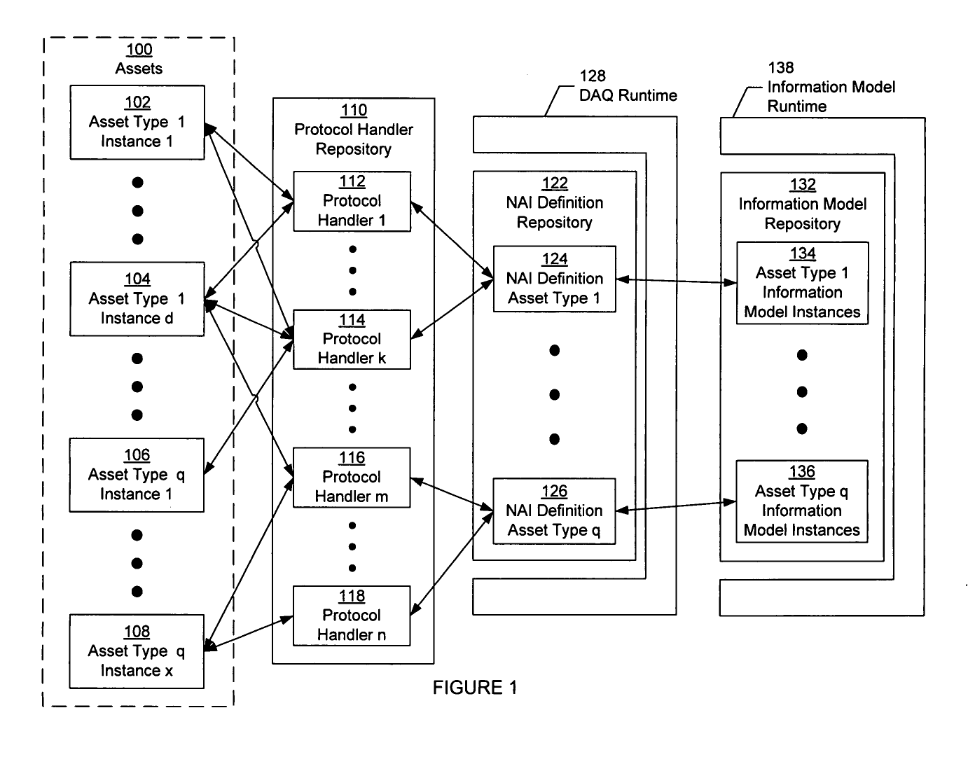

FIG. 1 shows a schematic diagram of a system for managing assets in accordance with one or more embodiments of the invention. As shown in FIG. 1, the system includes assets (100), a protocol handler repository (110), a native asset interface (NAI) definition repository (122), a data acquisition (DAQ) runtime (128), an information model repository (132), and an information model runtime (138) in accordance with one or more embodiments of the invention. Each of these components is described below.

An asset (100) corresponds to any type of actual manageable resource in accordance with one or more embodiments of the invention. Specifically, asset (100) corresponds to the resources that are the object of the management. For example, an asset may correspond to software (e.g., operating system, database application, network application, or any other type of software) or hardware (e.g., computer systems, routers, switches, etc.).

One attribute of an asset (100) corresponds to the asset type. An asset type specifies a group of characteristics of the asset. The asset type may specify a type of operating system, a type of hardware, a type of server, etc. For example, if the asset is an operating system, then the asset type for the asset may correspond to a particular operating system, such as Solaris™ developed by Sun Microsystems, Inc. (a trademark of Sun Microsystems, Inc. located in Santa Clara). In one or more embodiments of the invention, assets that have the attribute of the same asset type have the same native asset interface (NAI) for managing the resources of the asset.

An NAI corresponds to a collection of instrumentation and control interfaces that is provided by the asset for the purposes of managing the asset. For example, an NAI may correspond to command line programs, files, simple network management protocol (SNMP), Intelligent Platform Management Interface (IPMI), etc.

An asset type may have one or more instances (e.g., asset type 1/instance 1 (102), asset type 1/instance d (104), asset type q/instance 1 (106), asset type q/instance x (108)) of the asset type. In particular, assets that are of the same asset type are called instances of the asset type. For example, as shown in FIG. 1, asset type 1 has at least two instances (e.g., asset type 1/instance 1 (102) and asset type 1/instance d (104)), while asset type q has at least two separate instances (e.g., asset type q/instance 1 (106) and asset type q/instance x (108)).

Continuing with FIG. 1, the system also includes a protocol handler repository (110) in accordance with one or more embodiments of the invention. A protocol hander repository (110) corresponds to a storage unit, such as a file system or library, for protocol handlers (e.g., protocol handler 1 (112), protocol handler k (114), protocol handler m (116), protocol handler n (118)). A protocol handler (e.g., protocol handler 1 (112), protocol handler k (114), protocol handler m (116), protocol handler n (118)) corresponds to a logical component that includes functionality to directly access the data, methods, and functions of an asset (100). Specifically, the protocol handler (e.g., protocol handler 1 (112), protocol handler k (114), protocol handler m (116), protocol handler n (118) includes functionality to use the NAI of the asset in order to manage the asset.

In one or more embodiments of the invention, each protocol handler (e.g., protocol handler 1 (112), protocol handler k (114), protocol handler m (116), protocol handler n (118)) is designed for a single protocol or NAI. For example, one protocol handler (e.g., protocol handler 1 (112), protocol handler k (114), protocol handler m (116), protocol handler n (118)) may include functionality to manage assets that use the SNMP, another protocol handler may be designed for IPMI, while another protocol handler may be designed for assets that are managed through Integrated Light Out Management (ILOM) developed by Sun Microsystems, Inc. and another protocol handler may manage assets that use the Network Time Protocol (NTP). In one or more embodiments of the invention, only one protocol handler exists for any single protocol. Those skilled in the art will appreciate that multiple protocol handlers may exist for any single protocol for redundancy purposes.

Because the protocol handlers are associated with a single protocol, each protocol handler (e.g., protocol handler 1 (112), protocol handler k (114), protocol handler m (116), protocol handler n (118)) is connected to one or more asset instance (e.g., asset type 1/instance 1 (102), asset type 1/instance d (104), asset type q/instance 1 (106), asset type q/instance x (108)) in accordance with one or more embodiments of the invention. Specifically, assets (100) that have at least one common NAI are connected to the same protocol handler regardless of whether the assets are of the same asset type.

Similarly, each asset instance (e.g., asset type 1/instance 1 (102), asset type 1/instance d (104), asset type q/instance 1 (106), asset type q/instance x (108)) is connected to one or more protocol handlers (e.g., protocol handler 1 (112), protocol handler k (114), protocol handler m (116), protocol handler n (118)) in accordance with one or more embodiments of the invention. Specifically, each asset instance (e.g., asset type 1/instance 1 (102), asset type 1/instance d (104), asset type q/instance 1 (106), asset type q/instance x (108)) may be accessed by one or more protocol handlers (e.g., protocol handler 1 (112), protocol handler k (114), protocol handler m (116), protocol handler n (118)) that correspond to the protocols for managing the asset.

In addition to the protocol handler repository (110), the system includes a NAI definition repository (122). A NAI definition repository (122) corresponds to a storage unit, such as a library or file system, for NAI definitions (e.g., NAI definition asset type 1 (124), NAI asset type q (126)). An NAI definition (e.g., NAI definition asset type 1 (124), NAI asset type q (126)) corresponds to an abstraction of the management components of an asset in accordance with one or more embodiments of the invention. Specifically, an NAI definition stipulates how data acquisition is performed and how data is populated for access. Moreover, an NAI definition (e.g., NAI definition asset type 1 (124), NAI asset type q (126)) provides a common interface for defining the manageable components of the different assets. In one or more embodiments of the invention, each asset type has a single NAI definition (e.g., NAI definition asset type 1 (124), NAI asset type q (126)). Accordingly, the same NAI asset type definition may be used for multiple asset instances of the same asset type.

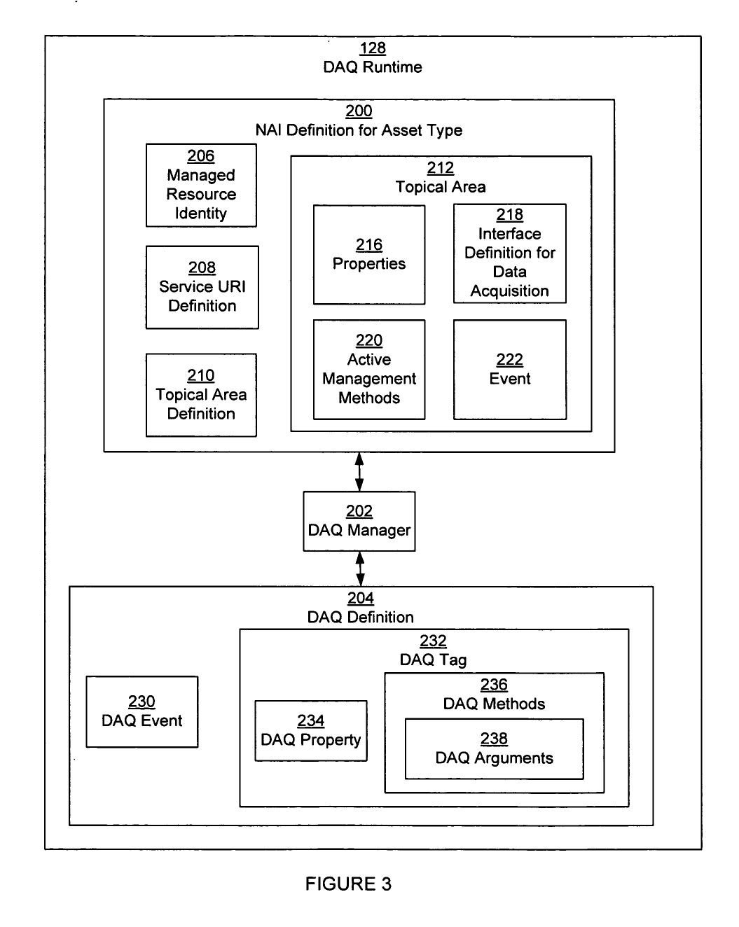

A data acquisition (DAQ) runtime (128) corresponds to a logical component that includes functionality to use a runtime binding of the NAI definition to manage the asset. Moreover, in one or more embodiments of the invention, the DAQ runtime (128) corresponds to the main focus of the system. Specifically, the DAQ runtime includes functionality to operate on NAI definitions (e.g., NAI definition asset type 1 (124), NAI asset type q (126)). The DAQ runtime (128), and the NAI definitions (e.g., NAI definition asset type 1 (124), NAI asset type q (126)) are described in more detail in FIG. 3.

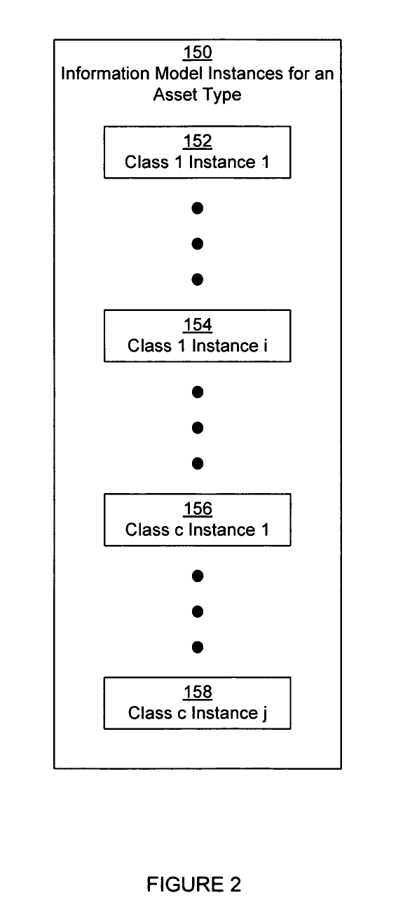

Continuing with FIG. 1, the NAI definitions (e.g., NAI definition asset type 1 (124), NAI asset type q (126)) are connected to an information model that includes the information model repository (132) and the information model runtime (138). An information model corresponds to a public interface for assets (100). The information model repository (132) corresponds to a storage unit for information model instances (e.g., asset type 1 information model instances (134), asset type q information model instances (136)). The information model instances (e.g., asset type 1 information model instances (134), asset type q information model instances (136)) are described in more detail in FIG. 2.

Continuing with the information model repository (132) of FIG. 1, the information model runtime (138) includes functionality to provide an execution environment for the information model repository (132). Specifically, the information model runtime (138) corresponds to the classes and methods of the information model during execution.

FIG. 2 shows a schematic diagram of information model instances for an asset type (150) in accordance with one or more embodiments of the invention. As shown in FIG. 2, each information model for an asset type includes multiple classes. A class corresponds to a collection of methods and properties that are common to a particular kind of component of the asset type. The method corresponds to the methods that can be used for managing an asset. The properties correspond to the manageable variables of an asset. For example, if the asset type is a particular type of server, a class may correspond to properties and methods for managing the operating system component for the particular type of server.

Each class includes multiple class instances (e.g., class 1/instance 1 (152), class 1/instance i (154), class c/instance 1 (156), class c/instance j (158)) in accordance with one or more embodiments of the invention. A class instance (e.g., class 1/instance 1 (152), class 1/instance i (154), class c/instance 1 (156), class c/instance j (158)) corresponds to an abstraction of an asset type instance in information model format. In one or more embodiments of the invention, the information model format corresponds to common information model (CIM) format (developed by Distributed Management Task Force, Inc. located in Portland, Oreg.). As shown in FIG. 2, the class instances (e.g., class 1/instance 1 (152), class 1/instance i (154), class c/instance 1 (156), class c/instance j (158)) for the information model may not be in a one to one relationship with the instances of the asset type for the class. In particular, some asset type instances may not have a corresponding instance for a particular information model class.

Each information model class instance (e.g., class 1/instance 1 (152), class 1/instance i (154), class c/instance 1 (156), class c/instance j (158)) is connected to a mapping specification (not shown) in accordance with one or more embodiments of the invention. The mapping specification includes functionality to map between the information model format and the DAQ format of the DAQ runtime. Accordingly, an information model class instance (e.g., class 1/instance 1 (152), class 1/instance i (154), class c/instance 1 (156), class c/instance j (158)) can manage virtually any asset without knowledge of the specific protocols used to manage the asset.

Alternatively, in one or more embodiments of the invention, each information model class instance (e.g., class 1/instance 1 (152), class 1/instance i (154), class c/instance 1 (156), class c/instance j (158)) may include the information required to format communication in the DAQ format in order to directly communicate with the DAQ runtime in accordance with one or more embodiments of the invention.

FIG. 3 shows a schematic diagram of a DAQ runtime (128) used for managing assets in accordance with one or more embodiments of the invention. As shown in FIG. 3, the DAQ runtime (128) includes an NAI definition for the asset type (200), a DAQ manager (202) and a DAQ definition (204) in accordance with one or more embodiments of the invention. Each of these components is described below.

An NAI definition for an asset type (200) corresponds to a description of the NAI for the asset. Specifically, for each manageable component of the asset type, the NAI definition defines how to manage the component using the NAI of the component. In one or more embodiments of the invention, the NAI definition includes a scheme or protocol (e.g., SNMP, IPMI, etc.), and a part that defines how to execute the NAI in context of the protocol. For example, suppose that information about a computer system are gathered by a command line command “uname-a.” Then the NAI definition may specify that the protocol is a shell, the location of the computer system, and the command “uname-a.”

In one or more embodiments of the invention, the NAI definition for the asset type (200) is defined using extensible markup language (XML). Specifically, the aforementioned components of the NAI definition are denoted by XML tags. Moreover, in one or more embodiments of the invention, the NAI definition complies with a predefined XML schema. The NAI definition for the asset type (200) includes a managed resource identity (206), a service URI definition (208), a topical area definition (210), and a topical area (212). Each of these components is described below.

The managed resource identity (206) corresponds to a definition of the asset type. Specifically, the managed resource identity (206) uniquely identifies the asset type in the NAI repository (not shown). In one or more embodiments of the invention, the managed resource identity (206) corresponds to an alpha-numeric identifier.

In addition to the managed resource identity (206), the NAI definition for the asset type (200) includes a service URI definition (208). The service URI definition (208) denotes how instances of the asset are enumerated. Specifically, the service URI definition (208) defines the scheme and method for identifying all instances of the asset type. For example, the service URI definition (208) may specify an enumeration service, a database, a discovery protocol, or any other mechanism for enumerating instances of an asset type.

The NAI definition for the asset type (200) also includes a topical area definition (210) in accordance with one or more embodiments of the invention. A topical area definition (210) identifies the different topical areas that can be managed for an asset type. For example, if the asset type is a computer system, then the topical area definition (210) may specify that the different manageable components of the asset type or topical areas of the asset type. For example, the topical areas may correspond to operating system, storage, networking, executing processes, or other such area.

In accordance with one or more embodiments of the invention, each topical area includes a topical area definition (212). The topical area definition (212) corresponds to a specification for managing the topical area. The topical area definition (212) includes properties (216), interface definitions for data acquisition (218), active management methods (220), and events (222). Each of these components is described below.

Properties (216) correspond to the information in the topical area about the asset type. Specifically, a property (216) corresponds to the information and data that can be set and obtained from an asset. For example, if the topical area corresponds to storage, then the properties may correspond to storage space, partitioning, amount of used space, etc. In one or more embodiments of the invention, the name of a property is unique within the namespace of the topical area. Further, in one or more embodiments of the invention, each property (216) includes a plurality of attributes. For example, the attributes of the property (216) may correspond to the name, a description, whether the property is able to be changed, the data type of values of the property, etc.

The interface definition for data acquisition (218) identifies how the properties (216) are populated in accordance with one or more embodiments of the invention. Specifically, the interface definition for data acquisition (218) specifies the scheme and method in the context of the scheme that is used to manage the asset in relation to the property. For example, the interface definition for data acquisition may correspond to snmp://target@host:port/1.3.6.2.1.1.1.*. The SNMP portion shows the scheme that is used to obtain a property as required by the NAI for the property is SNMP. The remainder portion of the example interface definition corresponds to the location for obtaining and setting the property on the asset.

Continuing with FIG. 3, the topical area definition (212) also includes active management methods (220). The active management methods (220) correspond to information about the methods that the NAI for the asset type provides in order to manage the asset by modification. For example, a method from the NAI may correspond to reset a particular value. The active management methods (220) identify how the value is reset. In one or more embodiment of the invention, active management methods (220) provide information for invoking the method for the NAI of the asset type.

Another component of the topical area definition (212) is an event (222). An event (222) corresponds to information for subscribing for notifications. Specifically, the NAI for the asset type generally includes mechanisms for receiving periodic notifications or only notification of changes. An event (222) corresponds to the definition of how to turn on the NAI for the notifications. For example, an event (222) may correspond to information about how to register for information about temperature.

In addition to the NAI definition for the asset type (200), the DAQ runtime (128) includes a DAQ definition (204) in accordance with one or more embodiments of the invention. A DAQ definition (204) corresponds to a runtime image of the NAI definition for the asset type (200). Specifically, the DAQ definition (204) corresponds to a runtime binding of the NAI definition for the asset type (200). For example, whereas in one or more embodiments of the invention, the NAI definition for the asset type (200) is in XML language, the DAQ definition (204) may correspond to an object oriented programming language. More specifically, a binding compiler (not shown) includes functionality to translate XML schema into one or more Java™ classes without requiring the developer to write complex parsing code. Moreover, in one or more embodiments of the invention, each DAQ definition (204) has the same names for the methods regardless of the different NAI definitions. Accordingly, the DAQ definition provides a common interface for each of the different asset types of the NAI definitions.

In one or more embodiments of the invention, the DAQ definition (204) includes a DAQ event (230) and a DAQ tag (232). A DAQ event (230) corresponds to a runtime binding of an event (222). Specifically, a DAQ event (230) includes functionality to compare an old value and new value for a property corresponding to the DAQ event (230). Further, the DAQ event includes functionality to register listeners for the DAQ event (230) and inform registered listeners of a current status (e.g., changes between the old and new value, no change, etc.) of the property associated with the DAQ event (230).

A DAQ tag (232) corresponds to a runtime image of the topical area definition (212). Accordingly, those skilled in the art will appreciate that a DAQ tag (232) exists for each topical area definition (212) in accordance with one or more embodiments of the invention. The DAQ tag (232) includes a DAQ property (234) and DAQ methods (236).

A DAQ property (234) corresponds to a runtime image of the properties definition (216). Similarly, DAQ methods (236) correspond to a runtime image of the active management methods (220). The DAQ methods (236) include DAQ arguments (238). The DAQ arguments (238) correspond to the arguments required by the NAI methods of the asset. For example, if the NAI method for an asset corresponding to storage is to change the partitioning of the storage, then the DAQ arguments for a DAQ method of partitioning may specify how the storage devised is partitioned.

Interposed between the DAQ definition (204) and the NAI definition for an asset type (200) is a DAQ manager (202). The DAQ manager (202) corresponds to a logical engine that includes functionality to perform a runtime binding of the NAI definition for the asset type (200) with the DAQ definition (204) in accordance with one or more embodiments of the invention. Further, the DAQ manager (202) includes functionality to identify the DAQ definition (204) for a given management request and trigger the operations required using the DAQ definition (204) for managing the asset according to the management request.

For example, in one exemplary implementation of one or more embodiments of the invention, the DAQ runtime includes functionality to process request of type get attributes, set attributes, invoke methods, and manage event subscription requests. The DAQ runtime processing of the requests in the exemplary implementation is described below.

In one or more embodiments of the invention, in response to a “get attribute” request the runtime includes functionality to perform the following. Specifically, in response to the “get attribute” request, the runtime includes functionality to determine the DAQ tag where the attribute of interest is located by accessing the DAQ definition associated with the asset. The DAQ definition can be located via the assets NAI specification document, which is bound at execution time into the DAQ definition object. Next, the runtime includes functionality to obtain from the DAQ definition object the URI associated with the DAQ tag in accordance with one or more embodiments of the invention. Specifically, the DAQ tag includes the URI definition for the obtaining value of the attribute from the NAI of the asset in accordance with one or more embodiments of the invention. After obtaining the necessary information for identifying the NAI for the asset, the runtime includes functionality to query the protocol handler repository to obtain the protocol handler that corresponds to the URI associated with the DAQ tag in accordance with one or more embodiments of the invention. Finally, the runtime includes functionality to perform an invocation of the protocol handler to obtain the value of the required attribute.

Continuing with the example, in one or more embodiments of the invention, in response to a “set attribute” request the runtime includes functionality to perform the following. Specifically, in response to the “set attribute” request, the DAQ runtime includes functionality to determine the location of the DAQ tag for setting the attribute of interest. Determining the location may be performed by accessing the DAQ definition object associated with the asset in accordance with one or more embodiments of the invention. Next, the DAQ runtime includes functionality to obtain the URI associated with the DAQ tag from the DAQ definition object for the attribute in accordance with one or more embodiments of the invention. After obtaining the necessary information to set the attribute, the DAQ runtime includes functionality to query the protocol handler repository to obtain the protocol handler that corresponds to the URI associated with the DAQ tag in accordance with one or more embodiments of the invention. Finally, the DAQ runtime performs invocations of the protocol handler found in the library to set the attribute with the requested value.

Continuing with the example, in one or more embodiments of the invention, in response to an “invoke method” request the runtime includes functionality to perform the following. Specifically, in response to the “invoke method” request, the DAQ runtime includes functionality to determine the DAQ tag where the method of interest is located by accessing the DAQ definition associated with the asset. After determining the DAQ tag, the DAQ runtime includes functionality to obtain the URI associated with the method to be invoked from the DAQ definition object in accordance with one or more embodiments of the invention. Once the necessary information to invoke the method is obtained, the DAQ runtime includes functionality to query the protocol handler repository to obtain the protocol handler that corresponds to the URI associated with the DAQ tag in accordance with one or more embodiments of the invention. Finally, the DAQ runtime includes functionality to perform a method invocation operation on the protocol handler that executes the API for the method to be invoked.

Lastly, in the example implementation, when the DAQ runtime receives an event subscription request, the DAQ runtime includes functionality to determine the DAQ tag for the subscription event of interest is located by accessing the DAQ definition associated with the asset. After determining the DAQ tag, the DAQ runtime includes functionality to obtain the URI associated with the DAQ tag from the DAQ definition object in accordance with one or more embodiments of the invention. Once the necessary information to invoke the method is obtained, the DAQ runtime includes functionality to query the protocol handler repository to obtain the protocol handler that corresponds to the URI associated with the DAQ tag in accordance with one or more embodiments of the invention. Finally, the DAQ runtime includes functionality to perform a subscription request operation using the protocol handler to obtain notification of events through the NAI of the asset.

As shown in the above example, the common interface through the DAQ allows for an information model to perform virtually any management functions on the asset that are exposed through the NAI of the asset without having the NAI of the asset in accordance with one or more embodiments of the invention. Specifically, using the aforementioned requests, virtually any management operation can be performed in accordance with one or more embodiments of the invention.

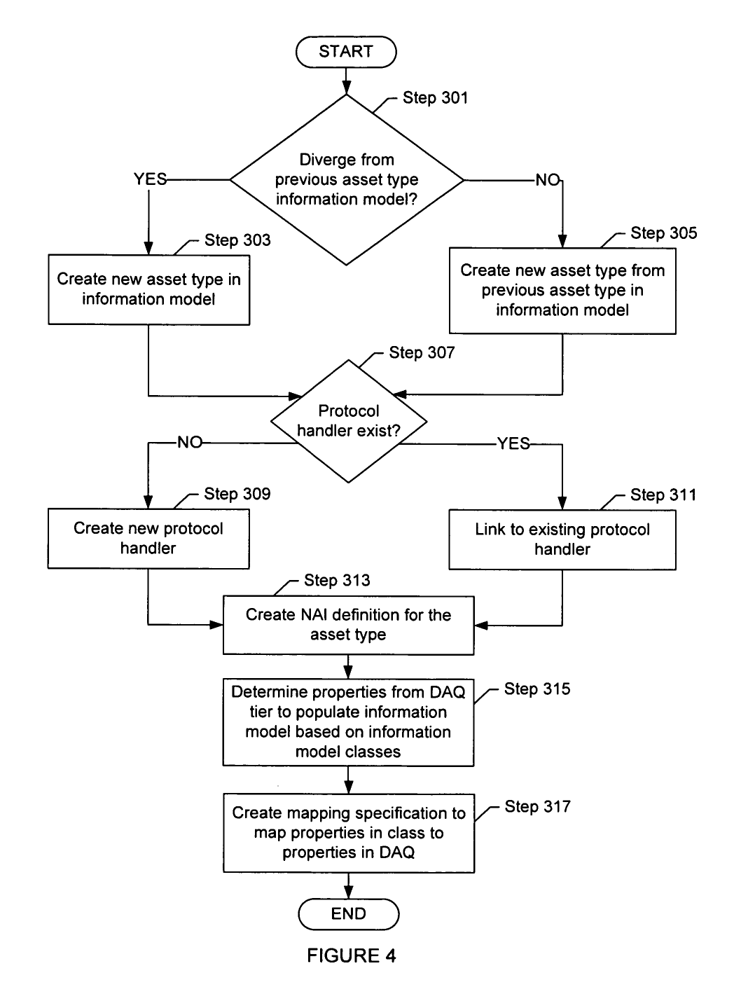

Also, using the DAQ runtime and the DAQ manager, new assets can be easily added to the system regardless of whether the new assets correspond to a preexisting asset type. If the new asset is of a preexisting asset type, then a new instance of the information model classes for the asset are created and information about the new asset instance is added to the DAQ. Alternatively, if the new asset is of a new asset type, then the system is configured to include the new asset type. FIG. 4 shows a flowchart of a method for adding a new asset type to the system in accordance with one or more embodiments of the invention.

Initially, a determination is made whether the new asset type diverges from a previous asset type in the information model (Step 301). A new asset type diverges from a previous asset type if the components of the new asset type (e.g., operating system, hardware, networking, etc.) are different than any existing asset type already defined in the information model in accordance with one or more embodiments of the invention. Determining whether a new asset diverges from a previously existing asset type can be performed by identifying the components of the new asset and comparing the components with the assets already in the information model.

If the new asset diverges from a previous asset type in the information model, then a new asset type is created in the information model (Step 303). Specifically, new classes are developed for managing the new asset of the new asset type.

Alternatively, if the new asset does not diverge from a previously existing asset, then a new asset type can be created from a previously existing asset type in the information model (Step 305). Specifically, any preexisting classes in the information model that can be used as a basis for the new asset type may be copied or inherited into the new classes.

After creating the new asset type, an instance of the newly developed classes is instantiated in the information model (not shown).

Continuing with FIG. 4, protocol handlers are also associated with the new asset. Specifically, a determination is made whether the protocol handlers exist for the new asset type (Step 307). Determining whether protocol handlers exist for the new asset can be performed by identifying the NAI of the asset type. Specifically, as part of the information about the asset of the new asset type or the configuration of the asset, the NAI, or interface for managing the asset type is revealed. The NAI specifies the protocols or schemes that are required for managing the asset type. Based on the specified protocols or schemes, a protocol handler can be identified.

If a protocol handler does not exist for the new asset, then a new protocol handler is created (Step 309). Specifically, at this stage, a new protocol handler is developed for the new asset. Developing the protocol handler may include creating any classes or functions for the protocol handler in a programming language in accordance with one or more embodiments of the invention.

Alternatively, if a protocol handler already exists for the asset type, then a link to the protocol handler is created (Step 311). Specifically, the NAI definition in the DAQ runtime links to the protocol handler.

Accordingly, using the newly created protocol handler or a preexisting protocol handler, the NAI definition for the asset is created (Step 313). At this stage, the mechanisms for managing the manageable components of the asset are identified. Based on the manageable components, the NAI definition is developed. Specifically, for each mechanism for managing the asset, a definition is added to the NAI definition for the asset. More specifically, the tags are identified and the information within the tags is populated in accordance with one or more embodiments of the invention. At any stage after creating the NAI definition and before the asset is managed, the DAQ manager may perform the runtime binding of the NAI definition to the DAQ definition. Performing the runtime binding may include, for example, parsing the NAI definition and creating a DAQ definition object for managing the asset using the information in the NAI definition.

In order to manage the asset of the new asset type, the information model instance must be link to the NAI definition. Accordingly, the properties from the DAQ tier to populate the information model are determined based on the information model classes (Step 315). Specifically, the procedures for populating the information model based on the NAI definition are identified.

Using the identified procedures, a mapping specification is created to map the properties in the information model class to the properties in the DAQ (Step 317). Creating the mapping specification may include identifying how the components of the information model correlate to the components of the DAQ. The mapping specification may then be created to reflect the correlation between components.

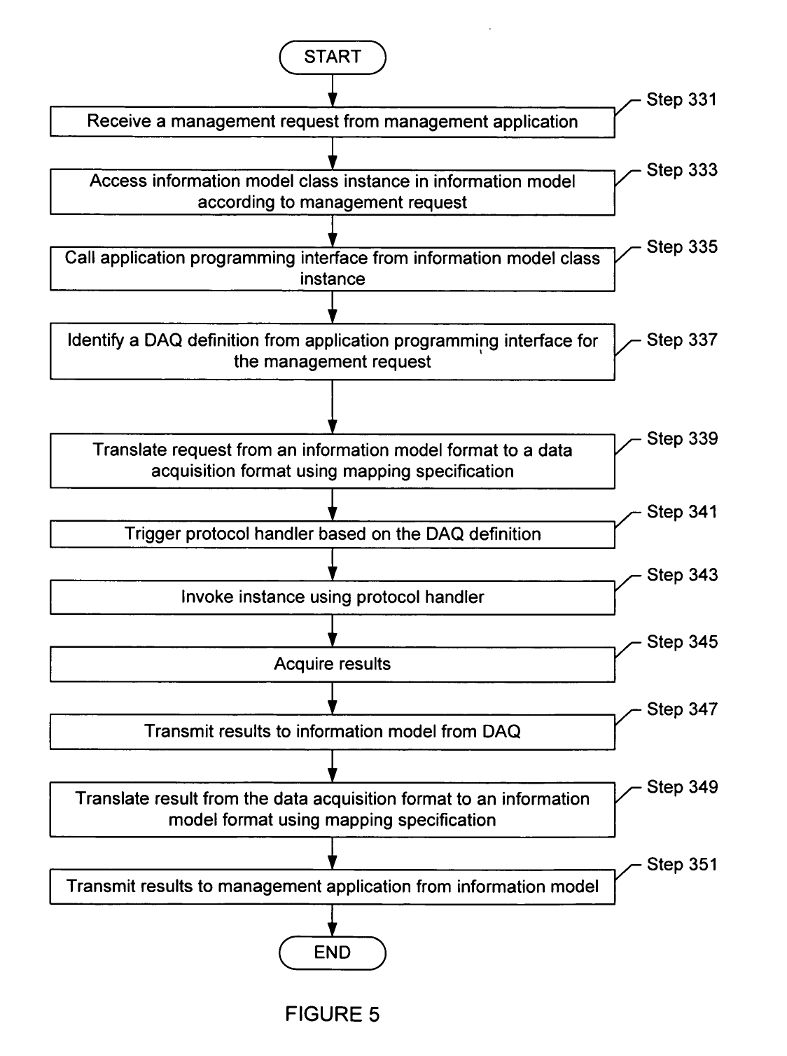

Once the mapping specification is created, instances of the information model are added, and the NAI definition is bound to the DAQ definition, the asset can be managed according to management requests. FIG. 5 shows a flowchart of a method for processing a management request in accordance with one or more embodiments of the invention.

Initially, a management request is received from a management application (Step 331). In one or more embodiments of the invention, the management request is received by the information model in information model format. More specifically, the management application submits a query to the information model using the API of the information model.

According to the management request, the information model class instance is accessed in the information model (Step 333). In particular, the management request may include one or more asset identifiers or an asset type identifier. Based on the identifiers and the type of request, information model asset type instance is identified and accessed. At this stage, the information model class instance may be triggered to perform the management function.

By accessing the information model class instance, an API is called from the information model class instance (Step 335). Specifically, the information model class instance includes a call to an API for managing the asset. The API may or may not have any resemblance to the NAI of the asset. In one or more embodiments of the invention, the call to the API is intercepted.

Next, the DAQ definition is identified via the NAI definition that is bound to the DAQ definition from the API for the management request (Step 337). Identifying the DAQ definition may be performed using virtually any technique known in the art. For example, a mapping specification may be queried for the DAQ definition corresponding to the management request. Alternatively, the DAQ manager may determine the type of management request and the asset type of the management request to identify the DAQ definition for the management request.

Once the DAQ definition is identified, the request is translated from the information model format to the data acquisition format using the mapping specification (Step 339). Specifically, the parameters from the request are formatted according to the requirements of the DAQ definition, and the any remaining necessary formatting changes known in the art may be performed. For example, the information model formatted request may be formatted in an information model language. Accordingly, the language of the request may be translated to a format that a DAQ language can understand.

Next, the protocol handler is triggered based on the DAQ definition (Step 341). Specifically, as previously stated, the DAQ definition identifies the protocol handlers and the mechanism for managing the asset using the protocol handlers. Based on the DAQ definition, the protocol handler is triggered with the information about the mechanism for the management. For example, suppose the DAQ definition corresponds to the runtime binding of the following NAI definition snmp://aggie@bevo:port/1.3.6.2.1.1.1.*. In such scenario, the protocol handler associated with the SNMP protocol is invoked with the information to obtain the management information from the location identified by: aggie@bevo:port/1.3.6.2.1.1.1.* in accordance with one or more embodiments of the invention.

Accordingly an asset instance is invoked using the protocol handler (Step 343). Specifically, the protocol handler uses the NAI that is identified by the NAI definition to invoke the management of the asset instance by the asset. By invoking the asset instance, the asset is managed and results may be acquired (Step 345). The results may correspond to actual management information, a success or failure indicator, or only to a change in control (e.g., return control of operations to the DAQ without returning data).

Once the results are acquired, the results are transmitted to the information model from the DAQ (Step 347). Specifically, in one or more embodiments of the invention, the information model class that called the API receives the results. Further, the results may be translated for the DAQ format to the information model format using the mapping specification (Step 349).

At this stage, the result may also be transmitted to the management application from the information model (Step 351). Transmitting the results from the information model format may be performed by a return statement of the information model.

As shown in FIG. 5, by using the DAQ definition and performing the translation, the information models, protocol handlers, and assets can be easily modified without unduly affecting the system. Specifically, the information model does not have to be aware of each NAI of each asset. Accordingly, an asset can be managed by a variety of management requests without having to modify the management application or the information model.

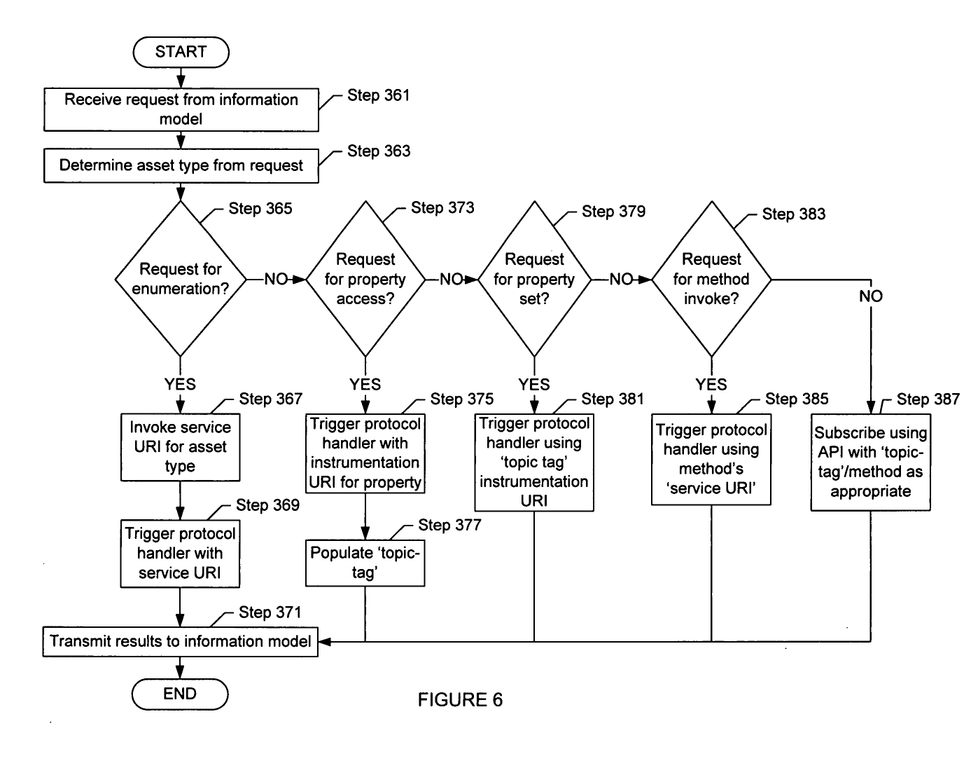

FIG. 6 shows a flowchart of a method for managing an asset at the data acquisition runtime in accordance with one or more embodiments of the invention. Specifically, FIG. 6 shows how the DAQ manages the asset based on a variety of management requests in accordance with one or more embodiments of the invention.

Initially, a management request is received from the information model (Step 361). At this stage, the management request is translated from the information model format to the DAQ format. Accordingly, the asset type from the management request is determined (Step 363). By determining the asset type, the DAQ definition for the asset type can be identified.

Next, a determination is made whether the management request is a request for enumerating instances of the asset type (Step 365). Specifically, during enumeration, all asset instances having a common attribute of the asset type are identified.

Accordingly, the service uniform resource identifier (URI) for enumerating instances of the asset type is invoked (Step 367). Specifically, the service URI is identified from the DAQ definition. Next, the protocol handler that is specified by the service URI is triggered (Step 369). The protocol handler then accesses the service identified by the service URI and requests the enumeration of the asset type (not shown). Based on the request, the service transmits identification, such as a network address, for the instances of the asset type. The protocol handler submits the identification to the DAQ runtime. In one or more embodiments of the invention, the DAQ manager then transmits the results to the information model (Step 371).

Alternatively, if the request is not for enumeration of asset instances, then a determination is made whether the request is for property access (Step 373). Specifically, a request property access corresponds to a request for obtaining the value for a property for an asset or an asset type in accordance with one or more embodiments of the invention.

If the request is for property access, then the protocol handler is triggered with the instrumentation URI for the property (Step 375). Specifically, at this stage, the DAQ tag is identified for the property. From the DAQ tag, in one or more embodiments of the invention, the instrumentation URI is obtained. The protocol handler is triggered with the obtained instrumentation URI. Based on the instrumentation URI, the protocol handler obtains the value for the property in accordance with one or more embodiments of the invention. Then the protocol handler returns the value for the property to the DAQ runtime.

The value for the property is then used to populate the topic tag (Step 377) in accordance with one or more embodiments of the invention. Specifically, the value is associated with the property in the DAQ topic tag of the DAQ definition for the asset type. By populating the DAQ tag, any further access to the property within a specified time frame may be obtained from the property in the DAQ in order to avoid unnecessary repetition. However, those skilled in the art will appreciate that rather then populating the topic tag, the DAQ runtime may pass the results directly to the information model. Regardless of whether the DAQ tag is populated, the value for the property is transmitted as results to the information model (Step 371).

Alternatively, if the request is not for property access, then a determination is made whether the request is for property set (Step 379). Specifically, the information model or management application may request that a value for the property be modified. If the request is for property set, then the protocol handler is triggered using the instrumentation URI (Step 381). The protocol handler then takes the value in the management request for setting the property and the URI specified in the topic tag for the property and updates the value at the asset instance using the NAI of the asset in accordance with one or more embodiments of the invention. After performing the aforementioned functions, the results of success or failure are returned to the information model (Step 371) in accordance with one or more embodiments of the invention.

Conversely, if the request is not for property set, property access, or for enumeration, then a determination is made whether the request is to invoke a method (Step 383). If the request is for method invoke, then the protocol handler is triggered using the method's service URI in the DAQ tag (Step 385) in accordance with one or more embodiments of the invention. At this stage, any arguments for the method are identified by the topic tag. The protocol handler is then triggered with the information about the method, the asset and the arguments. After the method completes, results from invoking the method are transmitted to the information model (Step 371).

Alternatively, if the request is not for method invoke, then the information model class instance may subscribe to management information. Specifically, periodic updates or changes in management data from an asset can be sent to an information model class instance. Accordingly, the information model subscribes to the management information using the API with the topic tag or method as appropriate according to the type of request (Step 387). As part of the subscription request, parameters for the subscription, such as periodic update parameter, threshold parameters, etc., may be specified.

By subscribing to management information, the information model class instance is registered as a registered listener for the management information. Thus, any updates to the management information are transmitted to the registered listeners, including the information model class instance (Step 371). For example, if an information model class instance subscribes to temperature changes of an asset, then any changes in the temperature may be transmitted to the information model.

Rather than using URI as specified in FIG. 6, those skilled in the art will appreciate that other mechanism exist for identifying the service, instrumentation, and methods. For example, the DAQ definition may include a reference to, or information about the API of the aforementioned mechanisms.

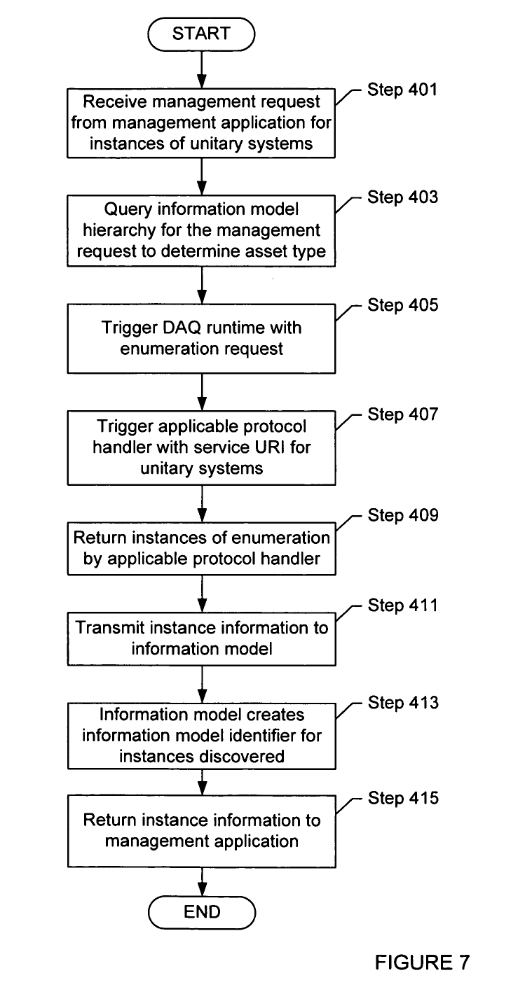

FIG. 7 shows a flowchart of an example of providing asset management information in accordance with one or more embodiments of the invention. In the following example, consider the case in which an administrator through a management application wants to know all of the instances of unitary systems (e.g., personal computers) on the network. Accordingly, the management application submits a management request for unitary systems (Step 401).

The management request is received from the management application for instances of unitary systems (Step 401). After receiving the management request, the information model class hierarchy is queried to determine the asset type of the management request (Step 403). At this stage, the information model class instance for enumerating instances of the unitary system is invoked and the API called with the enumeration request. By intercepting the API call and translating the request into DAQ format, the DAQ runtime is triggered with the enumeration request (Step 405).

Thus, the DAQ manager identifies the asset type and service URI for enumerating instances of the unitary systems in accordance with one or more embodiments of the invention. Based on the service URI, the applicable protocol handler is triggered (Step 407). The service URI may specify a discovery service that can enumerate instances of unitary system, a database in which instances of unitary systems register, or any other such mechanism. Regardless, the service URI for the unitary systems returns identification and information about the instances to the protocol handler.

Similarly, the protocol handler returns instances to the DAQ runtime (Step 409). At this stage, the DAQ runtime may register the instances in the DAQ definition before transmitting the instance information to the information model (Step 411) in accordance with one or more embodiments of the invention. The information model then creates new information model class instances for any instances of unitary systems that are not already in the information model (Step 413).

Next, the information model runtime returns the instance information to the management application (Step 415). Thus, the administrator is able to easily identify all instances of unitary systems regardless of the NAI of the asset or the management application that is used.

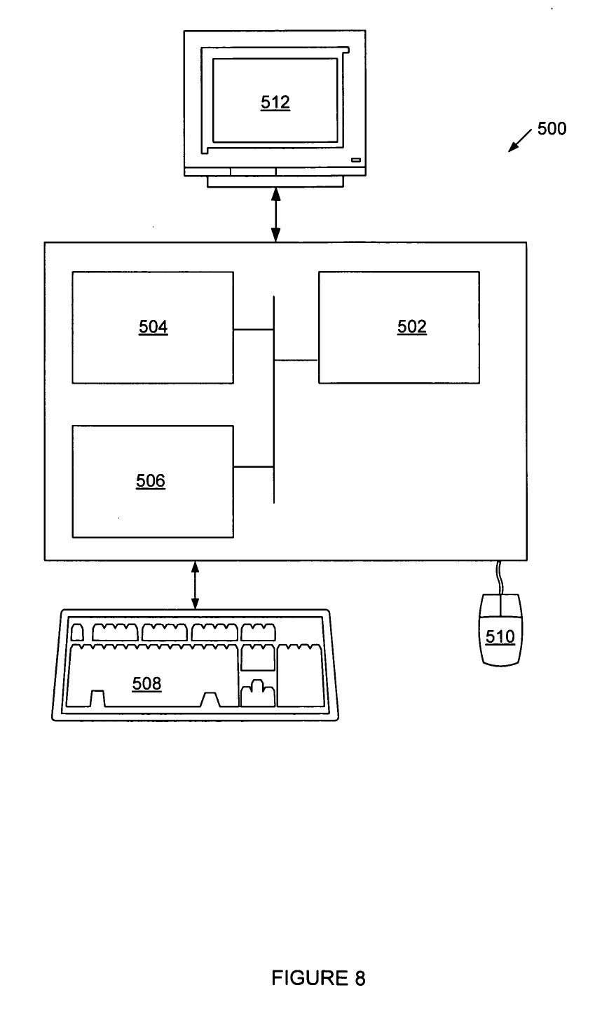

The invention may be implemented on virtually any type of computer regardless of the platform being used. For example, as shown in FIG. 8, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., NAI definition, DAQ definition, Information model repository, protocol handler repository, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention provide a mechanism for easy management of assets. Specifically, embodiments of the invention minimize the amount of framework code required for managing an asset. For example, by only adding metadata definitions to the DAQ runtime in the form of NAI definitions, new assets of new asset types can be easily added to the system. Specifically, when new assets are added to the system, the information model may only be adjusted to add class information for managing the new asset. The specific protocol information for the new asset and NAI specific methods for managing the asset do not need to be added to the information model. Accordingly, embodiments of the invention reduce the barrier of entry for new products to be instrumented and integrated into systems and network management framework.

Further, by separating the information model and the mechanism for obtaining management information about an asset, multiple information model class instances can obtain management information from the DAQ runtime without constant interruption to the asset. Accordingly, without the interruption, the performance of the asset may increase.

Further, embodiments of the invention provide a mechanism whereby the NAI for the asset can be updated as new technologies are developed without unduly affecting the management infrastructure. Specifically, if a protocol handler exists for the updated NAI, then only the definition needs to change for the asset.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing an asset comprising:
receiving a management request for the asset from a management application, wherein the management request complies with an information model format;
identifying a data acquisition (DAQ) definition for the management request;
translating the management request from the information model format to a data acquisition format, wherein the DAQ definition complies with the data acquisition format;
triggering a protocol handler according to the DAQ definition; and
managing the asset using the protocol handler.

2. The method of claim 1, further comprising:
identifying the asset type of the asset from the management request.

3. The method of claim 2, further comprising:
identifying an information model class instance within the asset type.

4. The method of claim 3, further comprising:
calling an application programming interface within the information model class instance, wherein the application programming interface triggers identifying the DAQ definition.

5. The method of claim 2, wherein identifying the DAQ definition is based on the asset type.

6. The method of claim 5, wherein triggering the protocol handler according to the DAQ definition comprises:
identifying the service uniform resource identifier (URI) from the DAQ definition;
triggering the protocol handler by invoking the service URI associated with the protocol handler.

7. The method of claim 5, wherein triggering the protocol handler according to the DAQ definition comprises:
identifying the method uniform resource identifier (URI) from the native asset interface definition;
triggering the protocol handler by invoking the method URI associated with the protocol handler.

8. The method of claim 5 wherein triggering the protocol handler according to the DAQ definition comprises:
setting a property in the DAQ definition; and
triggering the protocol handler to set the property on the asset.

9. The method of claim 5 wherein triggering the protocol handler according to the DAQ definition comprises:
identifying the protocol handler to obtain a property from the asset; and
triggering the protocol handler to obtain the property from the asset.

10. The method of claim 1, wherein the DAQ definition is the runtime binding of an NAI definition defined in extensible markup language.

11. A system for managing an asset comprising:
a data acquisition (DAQ) definition; and
a DAQ manager configured to:
receive a management request for the asset;
identify the DAQ definition for the management request; and
trigger a protocol handler according to the DAQ definition, wherein the asset is managed using the protocol handler,
wherein the management request complies with an information model format, and
wherein the management request is translated from the information model format to a data acquisition format, wherein the DAQ definition complies with the data acquisition format.

12. The system of claim 11, further comprising:
an information model for: identifying the asset type of the asset from the management request.

13. The system of claim 12, further comprising:
an information model for: identifying an information model class instance within the asset type.

14. The system of claim 13, further comprising:
an information model for: calling an application programming interface within the information model class instance, wherein the application programming interface triggers identifying the DAQ definition.

15. The system of claim 14, wherein identifying the DAQ definition is based on the asset type.

16. The system of claim 15, wherein triggering the protocol handler according to the DAQ definition comprises:
identifying the service uniform resource identifier (URI) from the DAQ definition;
triggering the protocol handler by invoking the service URI associated with the protocol handler.

17. The system of claim 15, wherein triggering the protocol handler according to the DAQ definition comprises:
identifying the system uniform resource identifier (URI) from the DAQ definition;
triggering the protocol handler by invoking the system URI associated with the protocol handler.

18. The system of claim 15 wherein triggering the protocol handler according to the DAQ definition comprises:
setting a property in the DAQ definition; and
triggering the protocol handler to set the property on the asset.

19. The system of claim 15 wherein triggering the protocol handler according to the DAQ definition comprises:
identifying the protocol handler to obtain a property from the asset; and
triggering the protocol handler to obtain the property from the asset.

20. A distributed computer system having a plurality of nodes for performing a method comprising:
receiving a management request for an asset from a management application, wherein the management request complies with an information model format;
identifying a DAQ definition for the management request;
translating the management request from the information model format to a data acquisition format, wherein the DAQ definition complies with the data acquisition format;
triggering a protocol handler according to the DAQ definition; and
managing the asset using the protocol handler,
wherein the management application and the protocol handler are executing on one or more of the plurality of nodes.
